(19) United States
(12) Patent Application Publication
(10) Pub. No.: US 2013/0223964 A1
(43) Pub. Date: Aug. 29, 2013

(54) TOWER-BASED PLATFORM SYSTEM FOR LIFTING COMPONENTS ATOP A WIND TURBINE TOWER

(71) Applicants: Danian Zheng, Simpsonville, SC (US); Biao Fang, Clifton Park, NY (US); Yan Liu, Singapore (SG); Aaron Mark Scott, Auckland (NZ)

(72) Inventors: Danian Zheng, Simpsonville, SC (US); Biao Fang, Clifton Park, NY (US); Yan Liu, Singapore (SG); Aaron Mark Scott, Auckland (NZ)

(73) Assignee: GENERAL ELECTRIC COMPANY, Schenectady, NY (US)

(21) Appl. No.: 13/405,576

(22) Filed: Feb. 27, 2012

(51) Int. Cl. B66F 11/00; E04G 21/14; B66B 11/00; B66B 9/00; E04H 12/34

(52) U.S. Cl. 414/560; 187/239; 414/589; 414/800

(57) ABSTRACT

A system and associated method are provided for lifting tower-top components from ground level to atop a wind turbine tower. A platform assembly is configured at least partially around a base of the wind turbine tower. Lifting cables are connected to the platform assembly and run to the top of the wind turbine tower and back down to ground. The platform assembly has a forward loading portion configured for securement of a tower-top component intended to be lifted to atop the wind turbine tower, wherein the platform assembly is engaged around the wind turbine tower and lifted by the cables to a position adjacent the top of the wind turbine tower for transfer of the tower-top component.

### FIELD OF THE INVENTION

The present disclosure relates in general to a system for lifting components to atop a wind turbine tower, and more particularly to a lifting platform assembly that engages around the wind turbine tower.

### BACKGROUND OF THE INVENTION

Wind power is considered one of the cleanest, most environmentally friendly energy sources presently available, and wind turbines have gained increased attention in this regard. A modern wind turbine typically includes a tower, generator, gearbox, nacelle, and one or more rotor blades. The rotor blades capture kinetic energy of wind using known airfoil principles. The rotor blades transmit the kinetic energy in the form of rotational energy so as to turn a shaft coupling the rotor blades to a gearbox, or if a gearbox is not used, directly to the generator. The generator then converts the mechanical energy to electrical energy that may be deployed to a utility grid.

As wind turbines increase in size and rotor height, the costs and logistics associated with erecting the wind turbines grow proportionately. Current wind turbine installations use large, specialized, cranes to lift the relatively heavy and bulky nacelle and rotor assembly (with hub and blades) to the top of the tower for subsequent mounting. These cranes are quite expensive to use, lease, and/or maintain, and often require dedicated road construction simply to bring the crane to the wind turbine site. To amortize the costs of the crane, developers often attempt to maximize the number of wind turbines at a particular wind farm location. However, these locations may have a limited footprint and are unable to support a large number of wind turbine sites. In addition, wind turbine sites at rough or inclined land may require repeated transportation, assembly, and disassembly of the massive cranes at substantial costs and time.

Thus, the ability to raise and mount the relatively heavy tower-top components (e.g., nacelle, rotor, blades) atop a wind turbine tower without relying on the large and often cost-prohibitive cranes would be advantageous.

### BRIEF DESCRIPTION OF THE INVENTION

Aspects and advantages of the invention will be set forth in part in the following description, or may be obvious from the description, or may be learned through practice of the invention.

In certain embodiments of the present subject matter, a system is provided for lifting tower-top components from ground level to atop a wind turbine tower. Although not limited to any particular tower-top component, the system is particularly well suited for lifting the nacelle (with or without rotor hub and blades), or the rotor hub and blade assembly. The system includes a platform assembly that mounts at least partially around the circumference of the tower base. Lifting cables are connected to the platform assembly and run to the top of the wind turbine tower and back down to ground level, for example to any manner of suitable ground-based retractor, such as a motorized or electric winch. The platform assembly includes a forward loading portion that is sized and structurally configured for securement of the particular tower-top component intended to be lifted atop the wind turbine tower. With this system, the platform assembly is engaged around the wind turbine tower and is lifted by the cables to a position adjacent the top of the wind turbine tower for subsequent transfer of the tower-top component.

The platform assembly may be variously configured. For example, the platform assembly may include a plurality of sub-parts that connect together at the wind turbine site to partially or completely encircle the tower. The platform assembly may include rollers (including bumpers or other friction reducing members) on an inner circumferential surface that engage against the wind turbine tower as the platform assembly is lifted.

In still a further embodiment, the system may include a rig configured on the platform assembly, with the rig having any configuration of structural members, lifting devices, cables, rails, rams, and the like, to move the tower-top component from the platform assembly to a mounting position atop the wind turbine tower.

In a particular embodiment, the front portion of the platform assembly is sized for receipt of a nacelle with rotor hub and at least one attached blade. The platform assembly may be raised to an intermediate position where the remaining blades are attached to the rotor hub prior to raising the platform assembly to position adjacent the top of the tower.

In another embodiment, a section of the front loading portion may be pivotally mounted to the back portion so as to be selectively moved to a generally vertical plane to change the orientation of the tower-top component from a load orientation to a mounting orientation. For example, in one embodiment, the pivotal section of the front loading portion is sized for secured receipt of a rotor hub and blade assembly, wherein the hub/blades are initially loaded onto the front loading portion with the blades generally parallel to the ground and straddling the tower. At a certain height above ground, the pivotal section can be pivoted so as to orient the rotor hub to a horizontal axis for subsequent mounting to the drive train atop the wind turbine tower. Any manner of suitable latching mechanism may be utilized between the pivotal section of the front loading portion and adjacent stationary portion of the platform assembly, including a manually operated device. In a particular embodiment, the latching mechanism is a remotely operated device, such as a radio operated device.

In certain embodiments, the pivotal section may be mechanically driven to the pivoted position. In other embodiments, the pivotal section may pivot from gravity and weight of the tower-top component. With this type of embodiment, any manner of suitable retarding device, such torsion springs, gas springs, hydraulic devices, and so forth, may be configured between the pivotal section and the back portion of the platform assembly to control the gravity-induced pivotal movement of the front loading portion upon release of the latching mechanism.

The present invention also encompasses various method embodiments for lifting tower-top components from ground level to atop a wind turbine tower by configuring a platform assembly at least partially around a base of the wind turbine tower and running lift cables from the platform assembly to the top of the wind turbine tower and back down to ground level. The tower-top component is secured to the platform assembly and, using the lift cables, the platform assembly is raised to a position adjacent to the top of the wind turbine tower. From this position, the tower-top component is moved from the platform assembly to a mounting position atop the wind turbine tower.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a perspective view of a conventional wind turbine having one or more tower-top components that may be lifted with an assembly in accordance with aspects of the invention;

FIG. 2 is a side view of a wind turbine tower with an embodiment of a lifting system configured thereon;

FIG. 3 is a side operational view of the lifting system of FIG. 2 used to raise a nacelle to atop of the wind turbine tower;

FIG. 4 is a side view of the lifting system of FIG. 2 with a rotor hub/blade assembly loaded thereon for subsequent lifting to the nacelle;

FIG. 5 is a side operational view of the lifting system of FIG. 4 with the pivotal front loading section moved to a position to orient the rotor hub/blade assembly for subsequent mounting;

FIG. 6 is a side view of the embodiment of FIG. 5 with the platform assembly at a position adjacent the tower top and the rig assembly being lowered for subsequent mounting of the rotor hub/blade assembly;

FIG. 7 is a top sectional view of an embodiment of a lifting assembly in accordance with aspects of the invention;

FIG. 8 is a side view of a wind turbine tower with an alternate embodiment of a lifting system;

FIG. 9 is a top view of the embodiment of the lifting system of FIG. 8;

FIG. 10 is a side view of the embodiment of FIG. 8 with the platform assembly at an intermediate position;

FIG. 11 is a side view of the embodiment of FIG. 10 with the platform assembly at a position adjacent to the top of the wind turbine tower; and

FIG. 12 is a side view of the embodiment of FIG. 11 after the tower-top component has been moved to the mounting position.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

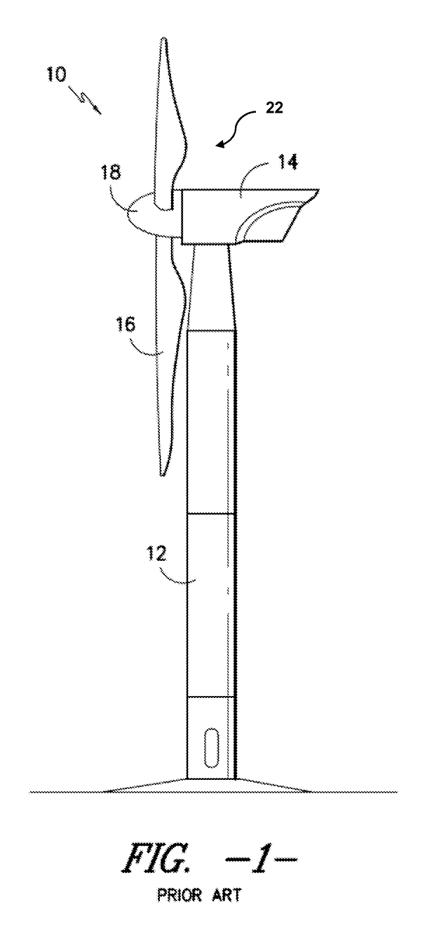

FIG. 1 illustrates a wind turbine 10 of conventional construction. The wind turbine 10 includes a tower 12 with typical tower-top components 22 mounted thereon, such as a nacelle 14. The tower-top components 22 may also include a plurality of rotor blades 16 mounted to a rotor hub 18, which is in turn connected to a main flange that turns a main rotor shaft (within the nacelle 14). The wind turbine power generation and control components are housed within the nacelle 14. The view of FIG. 1 is provided for illustrative purposes only to place the present invention in an exemplary field of use. It should be appreciated that the invention is not limited to any particular type of wind turbine tower configuration or tower-top component intended to be mounted atop the tower.

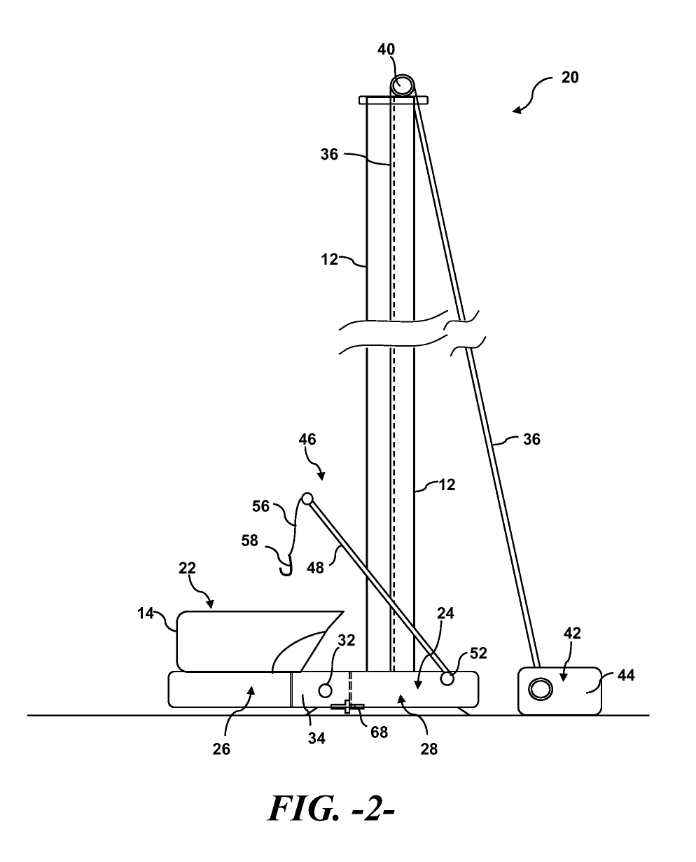

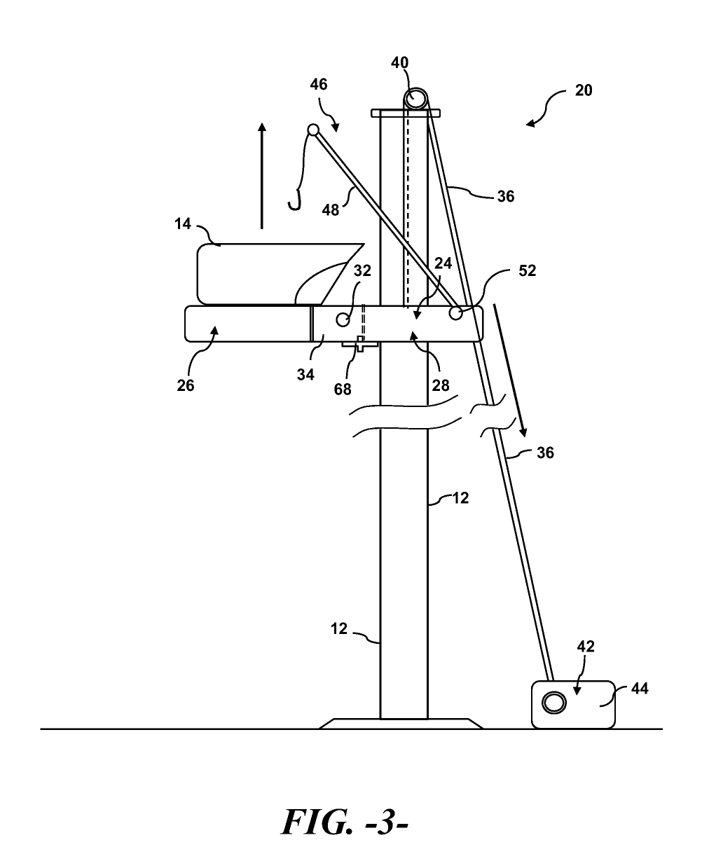

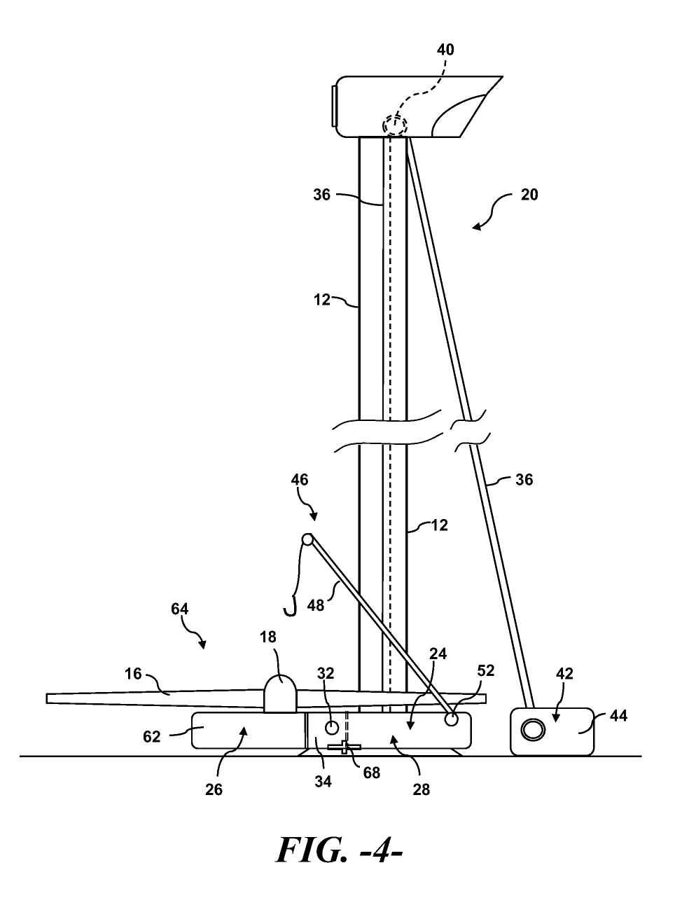

Referring to FIGS. 2 and 3, an embodiment 20 of a lifting system in accordance with aspects of the invention is illustrated. The system 20 is uniquely configured for lifting tower-top components 22 (such as a nacelle 14, rotor hub/blade assembly 64 (FIG. 4), nacelle and attached rotor/blade assembly, any manner of wind turbine drive train component, and so forth) atop an erected wind turbine tower 12. The wind turbine tower 12 may be, for example, a cylindrical steel tower, cement tower, lattice tower, and so forth. It should be appreciated that the invention is not limited to any particular type of tower construction.

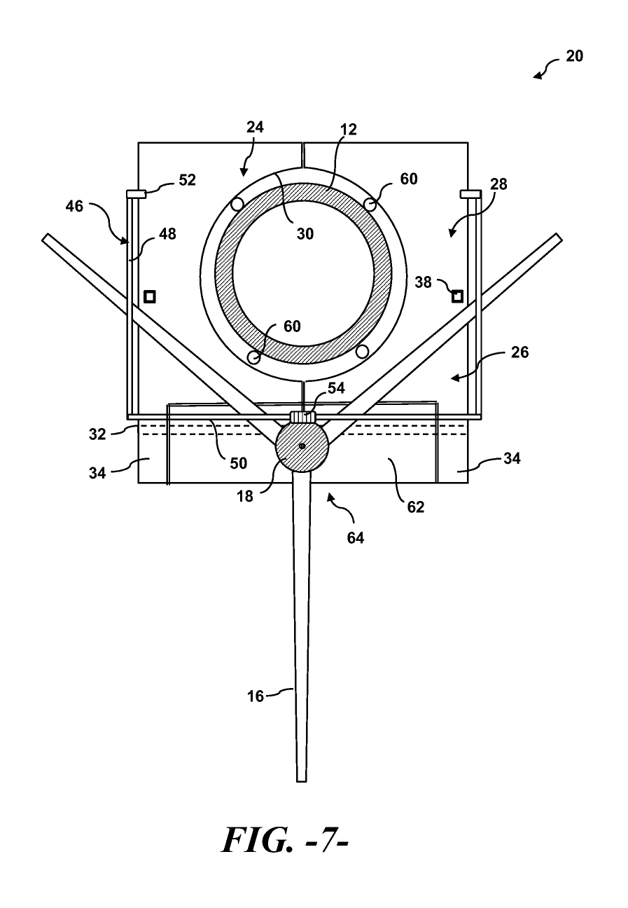

Still referring to FIGS. 2 and 3, the lifting system 20 includes a platform assembly 24 that is circumferentially configured around at least a portion of the base of the wind turbine tower 12. The platform assembly 24 may be variously configured. In the illustrated embodiment of FIGS. 2 and 3, the platform assembly 24 is a multi-part structure that may be transported to the wind turbine site and assembly around the base of the tower 12. The platform assembly 24 may be configured from any manner and configuration of structural elements that are sized and designed for lifting relatively heavy components to a mounting position adjacent the top of the tower 12. For purposes of explanation, the platform assembly 24 is referenced herein as having a back portion 28, which may be considered as the portion of the platform assembly 24 that encircles (at least partially or completely) the tower 12, and a forward loading portion 26, which may be considered as the portion of a platform assembly 24 that receives the tower-top component 22, as particularly illustrated in FIG. 2. The forward loading portion 26 and back portion 28 may be physically defined by structural elements, or may simply be considered as portions of a unitary assembly 24 (as in the embodiment of FIGS. 8 through 12).

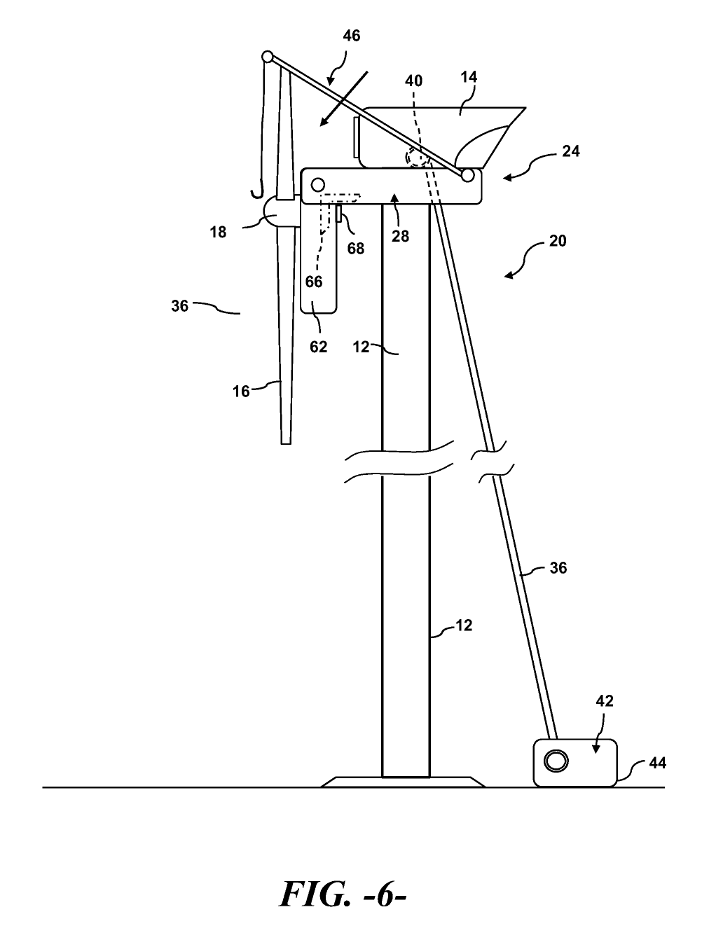

Any configuration of lifting cables 36 are connected to the platform assembly 24, for example at attachment points 38 (FIG. 7). Lifting cables 36 run from the platform assembly 24 to the top of the wind turbine tower 12, for example around any manner of pulley or other turn-around arrangement, and back down to ground. The cables 36 are attached to any suitable type of retractor mechanism 4, which may be, for example, any manner of electric or motorized winch 44 that is used to wind the lifting cables 36 and thus raise the platform assembly 24 relative to the tower 12.

With this configuration, the platform assembly 24 is engaged around the wind turbine tower 12 and lifted by the cables 36 and retractor 42 to a position adjacent to the top of the wind turbine tower 12 for subsequent transfer of the particular tower-top component 22. From this position, the tower-top component 22 may be subsequently transferred to a mounting position atop the tower 12, as discussed in greater detail below.

With the present lifting assembly 20, the previously erected tower 12 serves as the load bearing structure for subsequent lifting of the relatively heavy tower-top components 22 to a position atop of the tower 12. Thus, the logistical issues and expense of the previously used cranes (as discussed above) may be eliminated.

In the embodiment illustrated in FIGS. 2 and 3, a nacelle 14 is received on the forward loading portion 26 of the platform assembly 24, and is raised towards the top of the tower 12, as depicted in FIG. 3. Once the platform assembly 24 is adjacent to the top of the tower 12, any type of suitable rig 46 may be utilized to transfer the nacelle 14 to its mounting position atop the tower (as indicated in FIG. 4). The rig 46 may be configured on the platform assembly 24, or may be separately provided and constructed atop the wind turbine tower 12. In the illustrated embodiment of FIGS. 2 through 7, the rig 46 is a feature of the platform assembly 24 and is configured as a lifting mechanism for lifting the tower-top component 22 from the platform assembly 24 to a mounting position atop the tower 12. In this embodiment, the rig 46 may include side supports 48 pivotally connected to the back portion 28 of the platform assembly 24 at pivot points 52. A cross support 50 (FIG. 7) spans between the side supports 48 and supports any manner of winch 54, or other suitable equipment handling device. In the illustrated embodiment, the winch 54 is configured with a cable 56 and hook 58 for the purpose of latching onto a suitable connection point on the nacelle 14 (or other tower-top component 22) and lifting the component 22 from the assembly 24 while pivoting relative to pivot point 52 to move the component 22 to a position atop the tower 12.

Referring to FIG. 7, it should be appreciated that any manner of rollers 60, which includes bumpers, rails, or any other suitable friction-reducing mechanism, may be incorporated with the platform assembly 24 between an inner circumferential surface 30 thereof and the tower 12. These devices 60 serve to aid the platform assembly 24 in moving up and down the length of the tower 12.

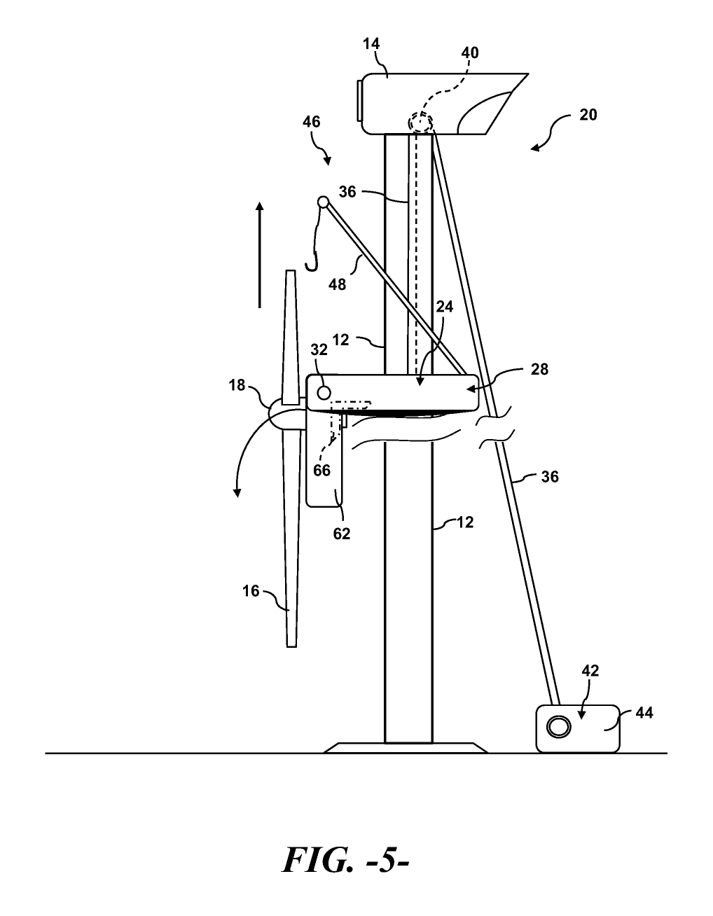

FIGS. 4 and 5 illustrate the lifting system 20 after the nacelle 14 has been mounted atop the wind turbine tower 12. The platform assembly 24 has been lowered back to ground level via the cables 36 and retractor 42 and a rotor hub/blade assembly 64 has been loaded onto the forward loading portion 26 of the platform assembly 24. It can be appreciated from FIGS. 4 and 7, in this particular embodiment, the rotor hub 18 is initially oriented in a vertical axis position and will need to be subsequently reoriented prior to mounting to a main flange on the nacelle 14. FIG. 7 depicts an orientation of the hub/blade assembly 64 on the forward loading section 26 wherein two of the rotor blades 16 straddle the tower 12, with the rotor hub 18 being fully supported on the platform assembly 24.

For purposes of re-orienting components initially loaded onto the platform assembly 24 prior to mounting the respective components, the platform assembly 24 may include a pivotal section 62 as part of the front loading portion 26. FIG. 5 depicts this pivotal section 62 after it has moved to a position to reorient the rotor hub 18 to a horizontal-axis position for subsequent mounting onto the main flange of the nacelle 14 from a position depicted in FIG. 6.

The pivotal section 62 may be variously configured. In the illustrated embodiment, the pivotal section 62 comprises a section of the front loading portion 26 defined forward of a pivot point 32. The pivotal section 62 may span the entire width of the front loading portion 26 or, in the embodiment illustrated in the figures, is contained between wings 34. This embodiment may be beneficial for ease of construction, assembly, and structural integrity. Regardless of its configuration, the pivotal section 62 has a sufficient size for receipt of the rotor hub 18, which is secured onto the pivotal section 62 by any suitable securement means.

A latching mechanism 68 is configured between the pivotal section 62 and the stationary (non-pivotal) portion of the platform assembly 24. This latching mechanism 68 may be any manner of mechanical device that releases the pivotal section 62 for subsequent repositioning. The latching mechanism 68 may be a manual device that must be manually manipulated or released in order for the pivotal section 62 to move by gravity and the weight of the rotor/blade assembly 64 thereon. In an alternate embodiment, the latching mechanism 68 may be remotely operated by, for example, a person at ground level that actuates the device once the platform assembly 24 has been lifted to a position wherein it is insured that the rotor blades 16 will clear the ground prior to pivoting of the section 62, as depicted in FIG. 5. The latching mechanism in this embodiment may be, for example, a radio-frequency operated mechanism.

It may also be desired to incorporate any manner of suitable retarding device 66 between the pivotal section 62 and the stationary portion of the platform assembly 24. This retarding device 66 serves to control the pivotal motion of the pivotal section 62 upon release of the latching mechanism 68. For example, the retarding device 66 may be a torsion spring, leaf spring, gas spring, hydraulic mechanism, and so forth.

FIG. 6 illustrates the platform assembly 24 raised to a top position on the tower 12. At this position, the rig 46 may be utilized to subsequently move the rotor hub 18 and attached blades 16 into a position for subsequent mounting onto the main flange in the nacelle 14.

As mentioned above, the lifting system 20 in accordance with aspects of the invention is not limited to the type of tower-top component 22 which may be received on the platform assembly 24. The system 20 may be used for subsequent lifting of any type of power train or control component for subsequent loading within the nacelle 14.

FIGS. 8 through 12 depict yet another embodiment of a lifting system 20 in accordance with aspects of the invention. In this embodiment, the platform assembly 24 is configured as a frame-type assembly around the tower 12 and includes a front loading portion 26 sized for receipt of any manner of tower-top component 22, which is illustrated as a nacelle 14 with attached rotor hub 18 and two blades 16. The third blade has not yet been attached to the rotor hub 18 in the initial position of the platform assembly 24 depicted in FIG. 8, which allows the nacelle 14 and hub 18 to be positioned on the front loading section with a horizontal orientation. Thus, the nacelle 14 and hub 18 can be raised to a position adjacent the top of the tower 12 without having to reorient the component 22 (as in the embodiment of FIGS. 2 through 7).

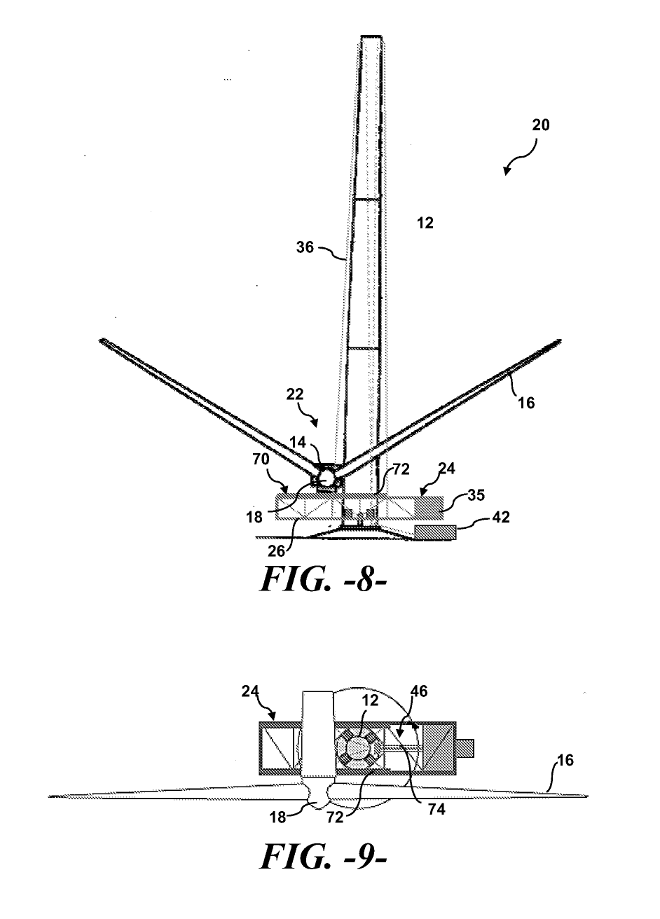

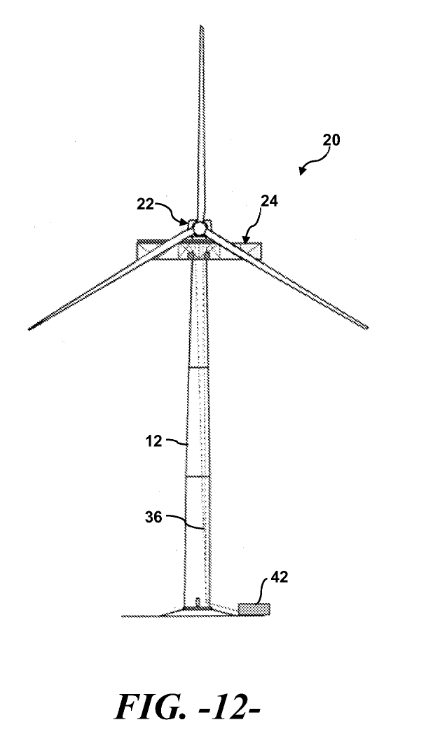

Referring to FIGS. 8 and 9, the rig 46 in this embodiment is configured as a rail assembly 70 that functions to linearly move the component 22 along the platform assembly 24 to its mounting position atop the tower 12. The rail assembly may include, for example, rails 72 that run along the top of the platform assembly 24 on opposite sides of the tower 12, with the component 22 resting on the rails 72. The rails 72 move linearly along the platform assembly 24. A ram 74, or any other suitable motive mechanism, may be configured to move the rails 74 in either liner direction so as to move the component 22 in the direction depicted by the arrow in FIG. 11.

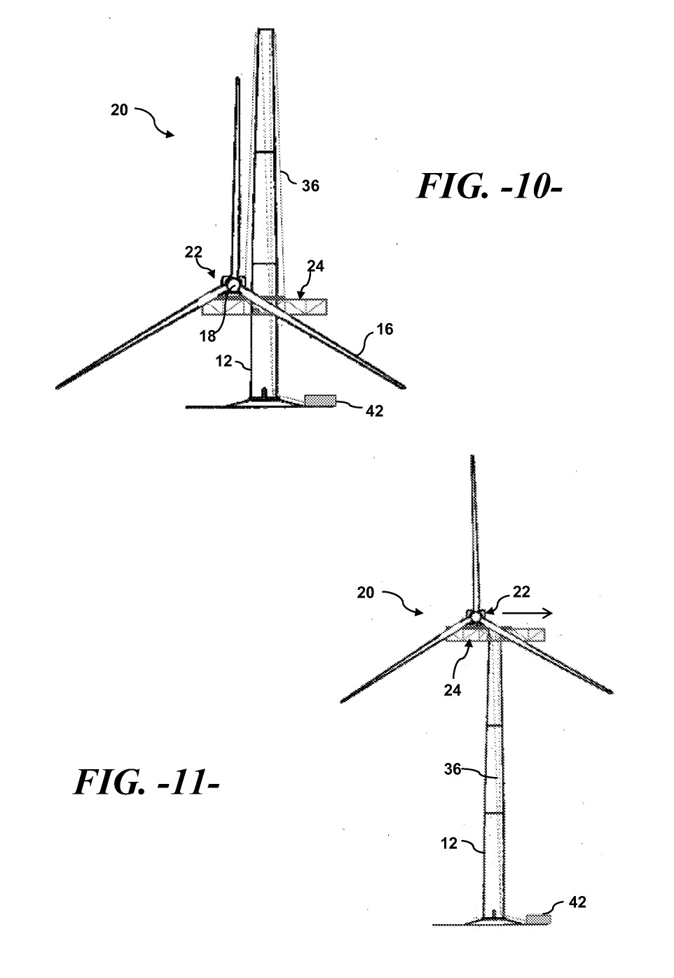

FIG. 10 depicts the platform assembly 24 in an intermediate height position relative to the tower 12. At this position, the hub 18 may be rotated and the third blade 16 attached to the hub. Once the third blade 16 is attached, the platform assembly 24 may be raised to the position adjacent to the top of the tower 12, as shown in FIG. 11.

Once the platform assembly 24 is at the position of FIG. 11, the component 22 (e.g., nacelle 14 with attached hub 18 and blades 16), may be linearly shifted along the direction of the arrow until the nacelle 14 is at the mounting position depicted in FIG. 12.

It should be appreciated that the present invention also encompasses various method embodiments in accordance with aspects discussed herein for lifting tower-top components 22 from a ground level to atop a wind turbine tower 12. For example, one suitable method includes configuring a platform assembly 24 at least partially around the base of the wind turbine tower 12 and running lift cables 36 from the platform assembly 24 to the top of the wind turbine tower 12 and back down to ground level. These cables 36 may be configured with any manner of suitable retractor 42, such as a motorized or electric winch. The method includes securing the tower-top component 22 onto the platform assembly 24 and, with the lift cables 36, raising the platform assembly 24 to a position adjacent to the top of the wind turbine tower 12. From this position, the method may include moving the tower-top component 22 from the platform assembly 24 to a mounting position atop the wind turbine tower 12.

Certain of the method embodiments may include configuring the platform assembly 24 by connecting a plurality of subparts together around the circumference of the wind turbine tower. These subparts may be separately transported to the wind turbine site and configured directly around the tower 12.

Certain of the method embodiments may include moving the tower-top component 22 from the platform assembly 24 to the mounting position atop the tower 12 with a rig 46 that is assembled on the platform assembly. This rig 46 may be configured to lift the component off of the platform assembly 24, or slide the component 24 along the platform assembly. In alternate embodiments, a rig may be separate provided, for example, separately configured at the top of the tower 12.

Certain of the method embodiments may also include pivoting a section of the platform assembly at a mid-level point of the assembly along the tower 12 so as to reorient the tower-top component 22 contained thereon, as described for example in the embodiment of FIGS. 5 and 6 above. This method may include releasing a latching mechanism 68 that allows the pivotal section of the platform assembly to move under gravity and weight of the tower-top component 22. This latching mechanism may be manually released or, in an alternate embodiment, remotely released.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A system for lifting tower-top components from ground level to atop a wind turbine tower, comprising:
a platform assembly that configures at least partially around a base of said wind turbine tower;
lifting cables connected to said platform assembly and running to the top of said wind turbine tower and back down to ground;
said platform assembly further comprising a forward loading portion configured for securement of a tower-top component intended to be lifted to atop said wind turbine tower; and
wherein said platform assembly is engaged at least partially around said wind turbine tower and lifted by said cables to a position adjacent the top of said wind turbine tower for transfer of the tower-top component.

2. The system as in claim 1, wherein said platform assembly comprises a plurality of sub-parts that connect together to completely encircle said wind turbine tower.

3. The system as in claim 2, further comprising rollers configured on an inner circumferential surface of said platform assembly that engage against said wind turbine tower.

4. The system as in claim 1, further comprising a rig configured on said platform assembly, said rig configured to move the tower-top component from said forward loading portion to a mounting position atop said wind turbine tower.

5. The system as in claim 4, wherein said rig comprises a lifting mechanism to lift the tower-top component from said platform assembly to the mounting position.

6. The system as in claim 4, wherein said rig comprises a rail assembly wherein the tower-top component is moved along said platform assembly with said rail assembly to the mounting position.

7. The system as in claim 1, wherein said front loading portion further comprises a pivotally mounted section that is selectively movable to a generally vertical plane to change the orientation of the tower-top component from a load orientation to a mounting orientation.

8. The system as in claim 7, wherein said pivotally mounted section is sized for secured receipt of a rotor hub and blade assembly, said pivotally mounted section movable to a position so as to orient the rotor hub to a horizontal axis.

9. The system as in claim 7, further comprising a latching mechanism between said pivotally mounted section and adjacent portion of said platform assembly.

10. The system as in claim 1, wherein said front loading portion is sized for receipt of a nacelle with attached rotor hub and blades.

11. A method for lifting tower-top components from ground level to atop a wind turbine tower, comprising:
configuring a platform assembly at least partially around a base of the wind turbine tower;
running lift cables from the platform assembly to the top of the wind turbine tower and back down to ground level;
securing the tower-top component to the platform assembly; and
with the lift cables, raising the platform assembly to a position adjacent to the top of the wind turbine tower; and
moving the tower-top component from the platform assembly to a mounting position atop the wind turbine tower.

12. The method as in claim 11, comprising configuring the platform assembly by connecting a plurality of sub-parts together completely around the circumference of the wind turbine tower.

13. The method as in claim 11, comprising lifting the tower-top component from the platform assembly to the mounting position with a lifting rig assembled on the platform assembly.

14. The method as in claim 11, comprising moving the tower-top component from the platform assembly to the mounting position along rails assembled on the platform assembly.

15. The method as in claim 11, wherein the tower-top component is a nacelle.

16. The method as in claim 11, wherein the tower-top component is a rotor hub and blade assembly, and further comprising pivoting a section of the platform assembly prior to reaching the mounting position to orient the rotor hub along a generally horizontal axis.

17. The method as in claim 11, wherein the tower-top component is a nacelle with rotor hub and at least one blade attached thereto, the method further comprising raising the platform assembly to an intermediate position and attaching any remaining blades to the rotor hub prior to raising the platform assembly to the position adjacent the top of the wind turbine tower.
